(19) United States
(12) Patent Application Publication
(10) Pub. No.: US 2020/0146203 A1
(43) Pub. Date: May 14, 2020

(54) GEOGRAPHIC COORDINATE BASED SETTING ADJUSTMENT FOR AGRICULTURAL IMPLEMENTS

(71) Applicant: CNH Industrial America LLC, New Holland, PA (US)

(72) Inventor: Yong Deng, Peoria, IL (US)

(73) Assignee: CNH Industrial America LLC

(21) Appl. No.: 16/189,180

(22) Filed: Nov. 13, 2018

(51) Int. Cl. A01B 79/00; G06K 9/00; G06K 9/62; A01B 76/00; A01M 7/00; A01C 21/00; B64C 39/02; G01C 21/20

(52) U.S. Cl. CPC A01B 79/005; G06K 9/0063; G06K 9/6217; A01B 76/00; G06N 20/00; A01C 21/005; B64C 39/024; G01C 21/20; A01M 7/0089

(57) ABSTRACT

In one aspect, a system for adjusting the operational settings of an agricultural implement includes at least one imaging system configured to generate aerial imagery of a geographic area, an agricultural implement configured to work the geographic area, and one or more computing devices in operative communication with the at least one imaging system and the agricultural implement. The computing devices are configured to process aerial imagery of the geographic area and create an operations-based geographic coordinate map including a set of operational settings for the agricultural implement based at least in part on the initial aerial imagery. The operations-based geographic coordinate map correlates the set of operational settings to the plurality of geographic coordinates. The computing devices are also configured to process updated aerial imagery of the geographic area and update the operations-based geographic coordinate map based on a comparison between the aerial imagery and the updated aerial imagery.

### FIELD OF THE INVENTION

The present subject matter relates generally to systems and methods for adjusting the operational settings of agricultural implements and, more particularly, to a system and method for adjusting the operational settings of an agricultural implement based on geographic coordinate maps refined through aerial imagery.

### BACKGROUND OF THE INVENTION

Current agricultural implements, such tillage implements, planters, seeders, sprayers, and the like, include operational settings that can be adjusted on-the-fly, based on operator input or automated sensing. It follows then that user error, isolated conditions, or other situational errors may result in inefficient adjustment of these settings. For example, isolated field conditions, weather conditions, visibility conditions, or sensor errors may contribute to inaccurate data, and therefore inaccurate settings. Thus, actively selecting the optimal operational settings in order to achieve desired productivity can be quite challenging.

Accordingly, a system and method for adjusting the operational settings for an agricultural implement based on geographic coordinate maps refined through aerial imagery would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a system for adjusting the operational settings of an agricultural implement. The system can include at least one imaging system configured to generate aerial imagery of a geographic area, an agricultural implement configured to work the geographic area, and one or more computing devices in operative communication with the at least one imaging system and the agricultural implement. The one or more computing devices are configured to process aerial imagery of the geographic area and create an operations-based geographic coordinate map including a set of operational settings for the agricultural implement based at least in part on the initial aerial imagery. The operations-based geographic coordinate map correlates the set of operational settings to the plurality of geographic coordinates. The one or more computing devices are also configured to process updated aerial imagery of the geographic area and update the operations-based geographic coordinate map based on a comparison between the aerial imagery and the updated aerial imagery.

In another aspect, the present subject matter is directed to a method for adjusting the operational settings of an agricultural implement coupled to a work vehicle. The method can include receiving, with one or more computing devices, initial aerial imagery associated with a geographic area, identifying, with the one or more computing devices, a plurality of geographic coordinates within the initial aerial imagery, and generating, with the one or more computing devices, an operations-based geographic coordinate map including a set of operational settings for the agricultural implement based at least in part on the initial aerial imagery. The operations-based geographic coordinate map correlates the set of operational settings to the plurality of geographic coordinates. The method also includes receiving, with the one or more computing devices, updated aerial imagery of the geographic area following at least partial completion of an agricultural operation in the geographic area, and adjusting the operations-based geographic coordinate map based on a comparison between the initial and updated aerial imagery.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a schematic view of one embodiment of a system for adjusting the operational settings of an agricultural implement, in accordance with aspects of the present subject matter;

FIG. 2 illustrates an example view of aerial imagery 200 generated by the system of FIG. 1.

FIG. 3 illustrates an example of geographic coordinates and features identified in the aerial imagery shown in FIG. 2;

FIG. 4 illustrates an example of an operations-based geographic coordinate map correlating a set of operational settings to the geographic coordinates identified in FIG, 3;

FIG. 5 illustrates an example of updated aerial imagery of the geographic area encompassed in FIG. 2 following completion of an agricultural operation.

FIG. 6 illustrates a flowchart of one embodiment of a method of adjusting the operational settings of an agricultural implement coupled to a work vehicle, such as the agricultural machine of FIG. 1, in accordance with aspects of the present subject matter; and

FIG. 7 illustrates a block diagram of an example computing system that can be used to implement methods in accordance with aspects of the present subject matter.

### DETAILED DESCRIPTION OF INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to systems, apparatuses, and methods for adjusting the operational settings of an agricultural implement. For example, a system can include an agricultural machine. The agricultural machine can include a work vehicle coupled to an agricultural implement. The particular work vehicle and agricultural implement are variable, but, in one embodiment, can include at least a work vehicle operated by an operator, and an agricultural implement coupled to and towed behind the work vehicle. In this manner, the agricultural implement may include a plurality of different forms, including a tiller, fertilizer, sprayer, planter, seeder, and/or other suitable implements.

The system can also include an imaging system configured to take aerial imagery of a geographic area. The imaging system can be operatively coupled to another vehicle, such as an unmanned aerial vehicle (UAV), configured to fly over the geographic area. Generally, the UAV may be equipped with a guidance system that allows for geographic coordinates and/or GPS waypoints to be correlated to the aerial imagery. Thus, through pre-processing, a geographic coordinate map including the aerial imagery may be generated.

The system can also include one or more processors configured to process the aerial imagery. The processors may process the imagery to identify features, masses, foliage, and other features that may require an adjustment to operational settings of the agricultural implement. For example, the processors may identify soil conditions (e.g., clods, wet/dry patches, etc.) that may require depth adjustment or down-force adjustments for the ground-engaging tools of the agricultural implement or other suitable changes to the implement's operational settings. The processors may also identify inclines, hills, declines, foliage, and/or other features that may require operational adjustments to the agricultural implement.

Following identification of such features, the processors may generate an operations-based geographic coordinate map including a set of operational settings for the agricultural implement based at least in part on the feature identification from the initial aerial imagery. The operations-based geographic coordinate map correlates the set of operational settings to the plurality of geographic coordinates associated with the geographic area imaged within the aerial imagery such that as the agricultural implement approaches or is generally proximate the identified features, the set of operational settings are engaged or executed when controlling the operation of the agricultural implement to increase the effectiveness of the agricultural operation being performed across the geographic area.

Upon completion of the agricultural operation within the geographic area, additional aerial imagery may be generated by the UAV and the associated imaging system. Using the additional aerial imagery, the one or more processors noted above may determine if any further adjustment(s) to the operational settings of the agricultural implement are necessary.

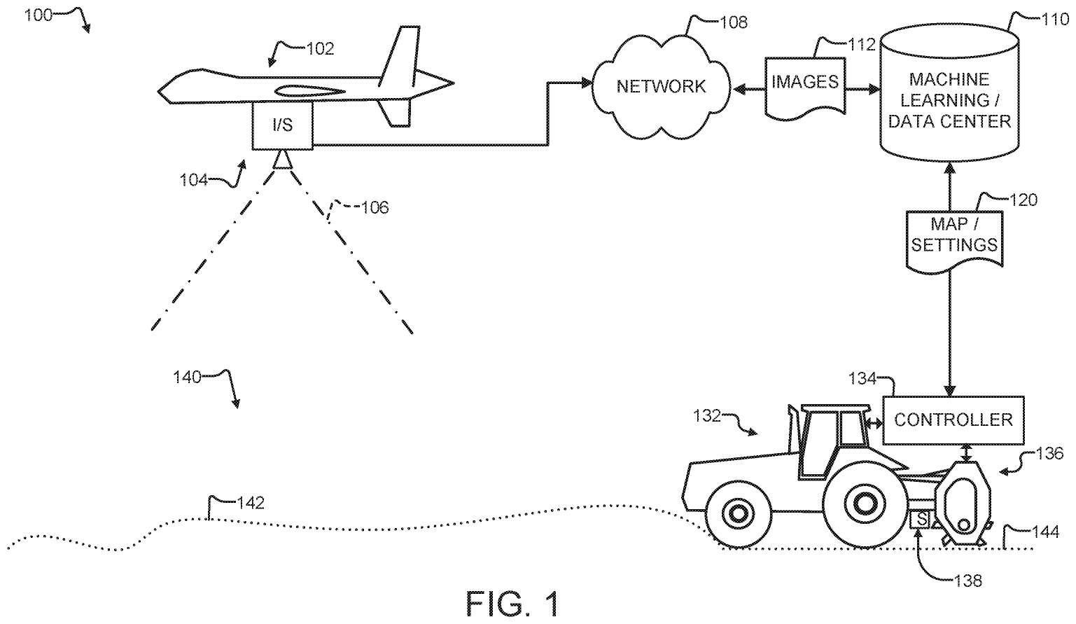

Referring now to the drawings, FIG. 1 illustrates a schematic view of one embodiment of a system 100 for adjusting the operational settings of an agricultural implement 136, in accordance with aspects of the present subject matter. As shown, the system 100 includes at least one imaging system 104 configured to generate aerial imagery of a geographic area 140. Generally, the imaging system 104 may include at least one camera or other suitable imaging device configured to receive visual data 106. According to the illustrated example, the imaging system 104 may be operatively coupled to an aerial vehicle 102. Accordingly, the imaging system 104 may be arranged to receive visual data 106 from a downward direction. Alternatively, the imaging system 104 may be operatively coupled to any other suitable vehicle or device for capturing imagery or vision data 106 of the geographic area 140, such as a satellite, a land-based drone or scout vehicle, and/or the like.

The aerial vehicle 102 may be a fixed wing, rotary wing, or other aircraft configured to fly above the geographic area 140. Alternatively, the aerial vehicle 102 may be an unmanned vehicle (UAV), such as a fixed wing UAV, helicopter, multi-rotor UAV, or other suitable UAV.

The system 100 may further include a network 108 configured to receive and transmit imagery or images 112 received from the imaging system 104. The network 108 may be any suitable network, including a wireless network having one or more processors or nodes configured to transmit packet data to computer apparatuses.

The system 100 further includes a machine learning or data center 110 configured to receive and process the images 112. The machine learning or data center 110 may include one or more processors arranged to implement a machine learning algorithm, such as a feature-based learning algorithm with an initial data set. The initial data set may be based on historical data, such as operational settings for an agricultural implement based on the size, depth, or other attributes of geographic features, such as hills, clods, wet/dry patches foliage, plants, or other features. The initial data set may be augmented by subsequent data sets generated through analysis of the success or degree of success of agricultural work in an agricultural area based on imagery taken before and after work by an agricultural implement. In this manner, incremental machine learning may be established such that future adjustments to operational settings may more closely result in desired changes to a geographic area being worked,

The machine learning or data center 110 may be configured to process aerial imagery 112 of the geographic area 140 and create an operations-based geographic coordinate map 120 including a set of operational settings for an agricultural implement 136. The map 120 may be based at least in part on initial aerial imagery received from the imaging system 104 and historical data. The map 120 may correlate a set of operational settings to a plurality of geographic coordinates such that the operation of the implement 136 may be adjusted depending upon where the implement 136 is performing work within the geographic area.

Generally, the map 120 may be transmitted to a controller 134 in operative communication with the implement 136 or a work vehicle 132 associated with the implement 136. As shown, the work vehicle 132 may be a tractor or other work vehicle capable of towing the implement 136 so as to perform an agricultural operation within an unworked portion 142 of the geographic area 140, thereby resulting in a worked portion 144 of the geographic area 140.

The controller 134 may initiate control of the agricultural implement 136 so as to perform an agricultural operation within the geographic area 140 based at least in part on the operations-based geographic coordinate map 120. The controller 134 may directly or indirectly adjust the operational settings of the implement 136. According to at least one embodiment, the controller 134 may be an “implement controller” in direct communication with the agricultural implement 136. According to other implementations, the controller 134 may be a “work vehicle controller” configured to adjust operational settings based on a communicative coupling between the agricultural implement 136 and the work vehicle 132.

As one example, the agricultural implement 136 can include or correspond to at least one of a sprayer, fertilizer, tillage implement, planter, or seeder. In this regard, the controller 134 may adjust any suitable operational settings of the same. In another example, the agricultural implement 136 can include a non-powered implement, such as a plow. In that regard, the controller 134 may adjust downward force or speed of the implement 136 by adjusting associated operational settings of the work vehicle 132.

Generally, the set of operational settings for the agricultural implement 136 can include an initial set of operation settings. The initial set of operational settings can be matched to the operations-based geographic coordinate map 120 based on historical data. The historical data can include binary data, such as simple success / failure of a given agricultural operation, or can include granular data such as degree of success/failure of a given agricultural operation. The historical data can also include relevant operational settings resulting in success/failure. The relevant operational settings may be correlated to geographic features such as soil moisture, clod size, elevation, incline, foliage, vegetation, or other features identifiable in aerial imagery. In addition, the historical data can any other combination of the above-referenced parameters, such as by correlating the success/failure of a given agricultural operation to a given set of operational setting in association with a given set of identified field features.

As described briefly above, the machine learning or data center 110 may be configured to implement a machine learning algorithm or a deep-learning artificial intelligence algorithm to create the operations-based geographic coordinate map 120. The machine learning algorithm may use a change in the initial aerial imagery and post-work imagery to determine a degree of success. Thus, through continued operation, the machine learning or data center 110 may implement new adjustment data to more definitively ensure that the map 120 includes appropriate operational settings for working a geographic area.

Generally, the machine learning or data center 110 may transmit the generated operations-based geographic coordinate map 120 to the controller 134. Upon receipt, the controller 134 may execute the set of operational settings such that the operation of the implement 136 is appropriately adjusted based on the location of the implement 136 within the geographic area 140. Specifically, as the work vehicle 132 tows the agricultural implement 136 across the area 140, the controller 134 may actively control the operation of the implement 136 according to the operations-based geographic coordinate map 120 to allow localized adjustments to be made to the implement operation based on the operational settings determined using the initial aerial imagery. Finally, upon completion or at least partial completion of the work, the machine learning or data center 110 may direct the imaging system 104 to update the aerial imagery in response to the agricultural operation being performed across all or a portion of the geographic area 140.

It should be appreciated that, in one embodiment, the operational settings associated with the operations-based geographic coordinate map 120 may be static or fixed. Alternatively, the controller 134 may be configured to make on-the-fly or dynamic adjustments during performance of the agricultural operation within the geographic area 140. For example, the controller 134 may be configured to update the operational settings during operation based on data received from one or more sensors 138. The data received from the one or more sensors 138 can include, for example, water content, fertilizer content, soil levels, tillage alignment, crop concentration, or vehicle row alignment. Other suitable data may also be sensed. In this manner, on-the-fly adjustments to the initial operational settings may be used to more efficiently work the geographic area 140.

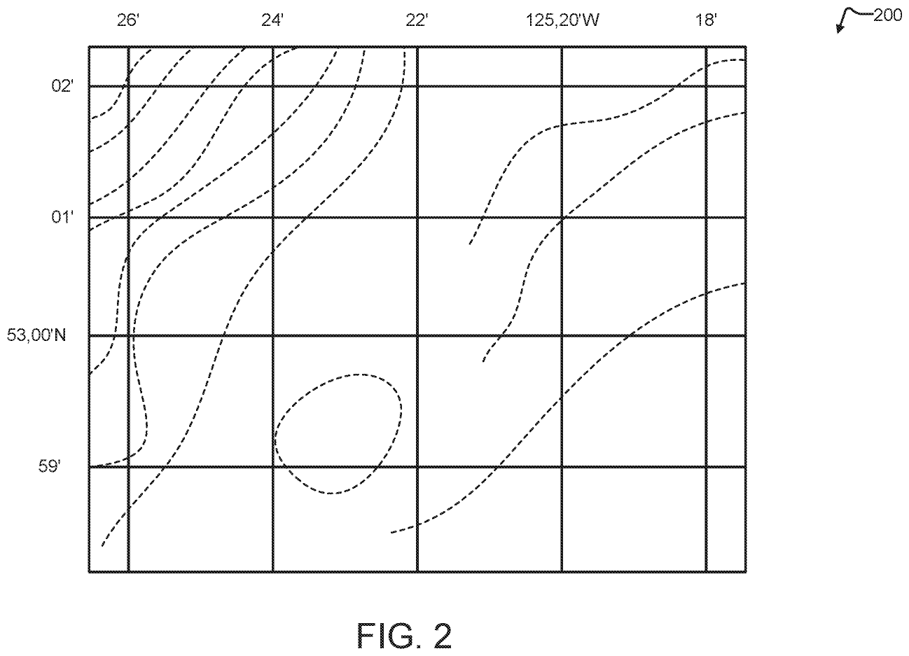

Hereinafter, a more detailed discussion of the generation of the map 120, and adjustment of the initial operational settings of the agricultural implement 136, are described more fully with reference to FIGS. 2-5. FIG. 2 illustrates example aerial imagery generated by the imaging system 104 of FIG. 1. As shown, the imagery 200 includes geographic coordinates overlaid onto the imagery. The geographic coordinates may be provided, for example, by GPS or other navigational systems onboard the UAV 102. In the example imagery, the geographic coordinates are based on latitude and longitude. However, it should be understood that any geographic coordinate system may be used, depending upon any desired implementation. Upon receipt of the initial imagery 200, the machine learning or data center 110 may process the imagery 200 to identify geographic features.

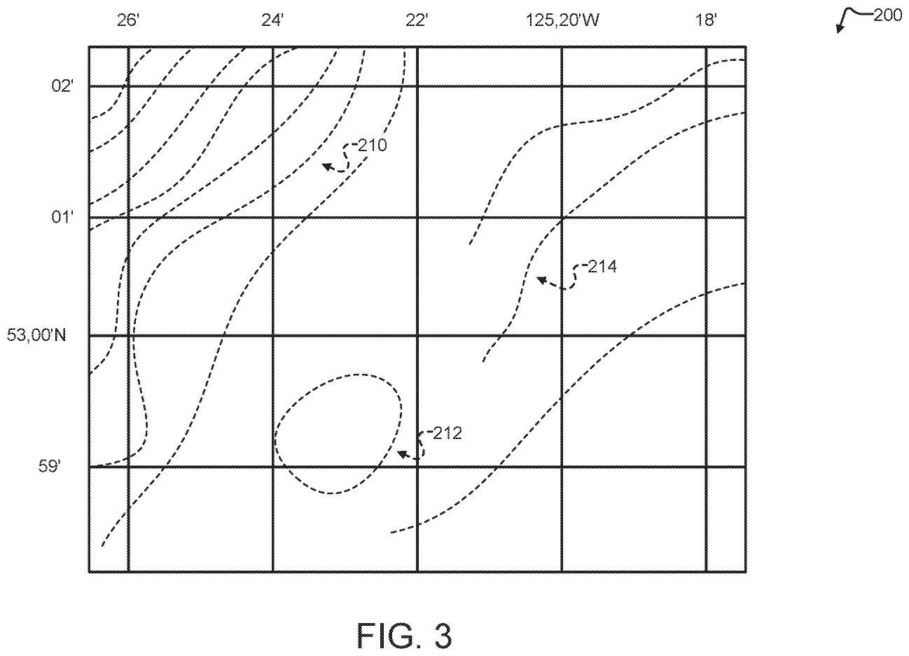

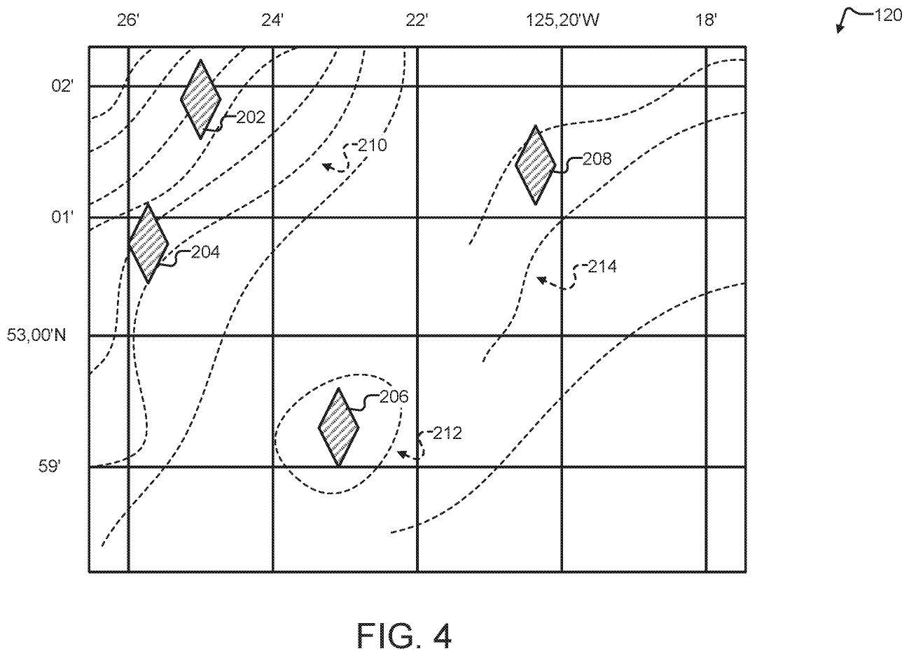

For example, FIG. 3 illustrates an example view of geographic coordinates and features identified in the aerial imagery of FIG. 2. As shown, geographic features 210. 212, and 214 are identified. It should be understood that other geographic features may also be identified, and. FIG. 3 represents only a single example for purposes of description. During processing, the machine learning or data center 110 may identify features 210, 212, and 214 as requiring operational settings outside of an initial or base set of operational settings. For example, the topographical incline of feature 210 may require adjustment to ensure proper working of the associated areas. Furthermore, field condition feature 212 (e.g., a wet patch having high soil moisture) may also require additional operational setting changes. Moreover, features 214 may require operational settings changes aside from those identified from features 210 and 212. Accordingly, the machine learning or data center 110 may determine required or desired operational settings to tackle each feature identified, as shown in FIG. 4.

FIG. 4 illustrates an operations-based geographic coordinate map 120 correlating a set of operational settings 202, 204. 206, and 208 to the plurality of geographic coordinates of FIG. 3. The operational settings 202, 204, 206, and 208 may be arranged to alter the operational settings of the agricultural implement 136 as the work vehicle 132 approaches or is proximal the identified features 210, 212, and 214. In this manner, the operational settings of the agricultural implement 136 may be adjusted based on geographic positioning, as opposed to operator changes. Furthermore, sensor data, such as data received from sensors 138, may be used to further alter the operational settings 202, 204, 206, and 208 to more efficiently work the geographic area 140.

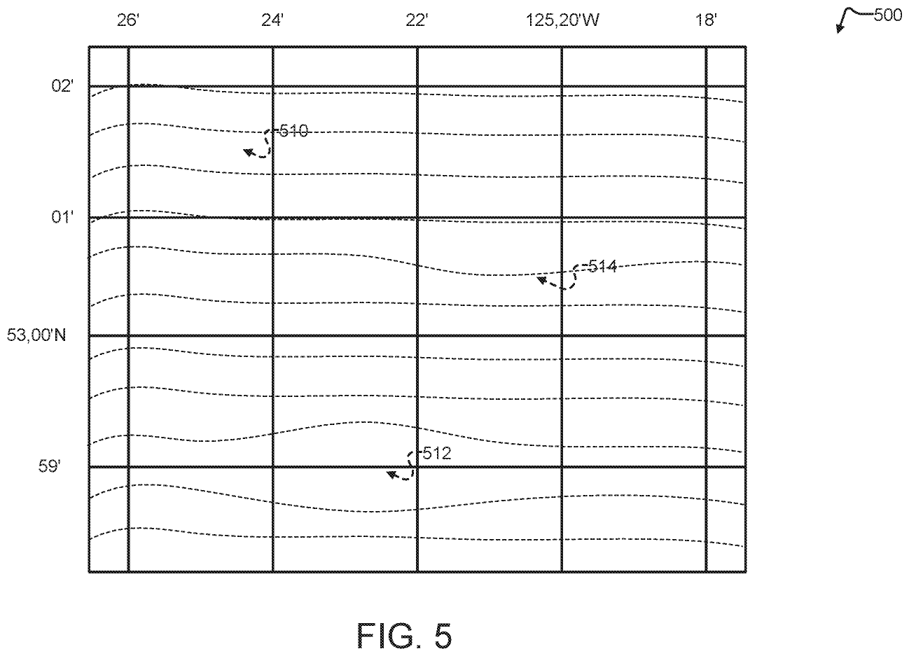

Following working of the geographic area 140, updated aerial imagery may be received from the imaging system 104. For example, FIG. 5 illustrates updated aerial imagery 500 of the geographic area 140 encompassed in FIG. 2 following completion of an agricultural operation. As shown, new features 510, 512, and 514 denote worked over areas 210, 212, and 214. Depending upon the characteristics of these new features, updated operational settings may be chosen by the machine learning or data center 110 for future agricultural operations.

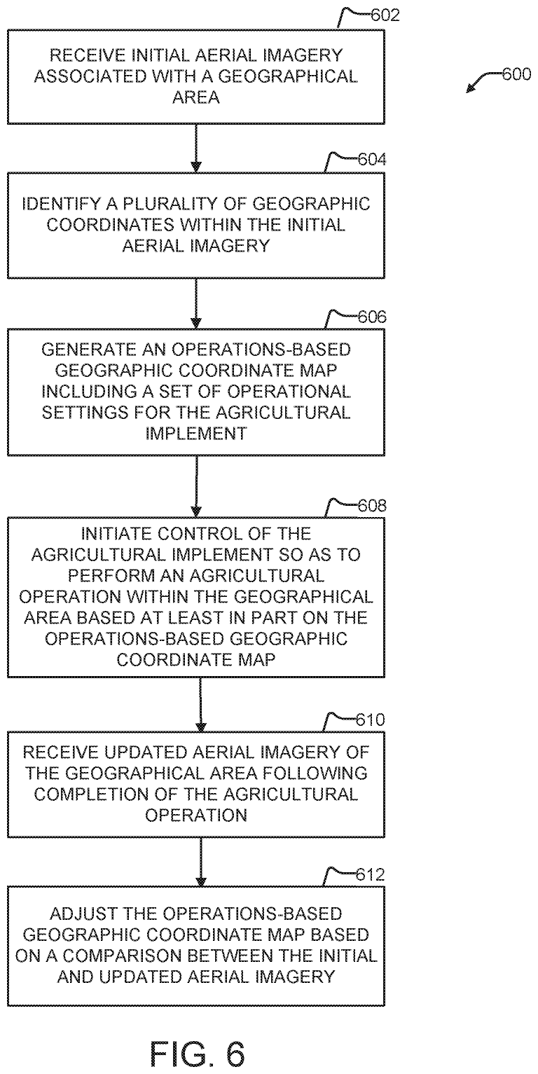

Hereinafter, methods of adjusting the operational settings of an agricultural implement are described more fully with reference to FIG. 6. FIG. 6 illustrates a flowchart of one embodiment of a method 600 of adjusting the operational settings of an agricultural implement 136 coupled to a work vehicle 132, in accordance with aspects of the present subject matter.

The method 600 may include receiving, with one or more computing devices, initial aerial imagery 200 associated with a geographic area 140, at block 602. The initial aerial imagery may be provided by the imaging system 104, for example.

Thereafter, the method 600 can include identifying, with the one or more computing devices, a plurality of geographic coordinates within the initial aerial imagery 200, at block 604. For example, navigational systems on the UAV 102 or GPS coordinates may be used to identify the geographic coordinates.

The method 600 may further includes generating, with the one or more computing devices, an operations-based geographic coordinate map 120 including a set of operational settings 202, 204, 206, and/or 208 for the agricultural implement 136 based at least in part on the initial aerial imagery 200, at block 606. The operations-based geographic coordinate map 120 may correlate the set of operational settings 202, 204, 206, and/or 208 to the plurality of geographic coordinates such that the agricultural implement 136 may receive new operational settings depending upon a location in the geographic area 140. Accordingly, operational settings of the agricultural implement 136 may change depending upon a physical location of the implement within the area 140.

The method 600 may further include initiating control, with the one or more computing devices, of the agricultural implement 136 so as to perform an agricultural operation within the geographic area 140 based at least in part on the operations-based geographic coordinate map 120, at block 608. Initiating control may include initiating control through controller 134 such that the agricultural implement 136 may work the geographic area 140.

Upon completion of work, or during work of the geographic area 140, the method 600 may include receiving, with the one or more computing devices, updated aerial imagery 500 of the geographic area 140 following at least partial progress of the agricultural operation, at block 610. The updated aerial imagery 500 may be provided by the imaging system 104.

Additionally, the method 600 may include adjusting the operations-based geographic coordinate map 120 based on a comparison between the initial and updated aerial imagery 500, at block 612. The comparison may be facilitated by the machine learning or data center 110. The comparison may include post-processing, with the one or more computing devices, the updated aerial imagery 500 to determine if the set of operational settings associated with the operations-based geographic coordinate map 120 requires adjustments.

Generally, the comparison may include a feature-based comparison of the updated aerial imagery 500 against the initial aerial imagery 200. The updated aerial imagery 500 may be correlated to the initial aerial imagery 200 using the geographic coordinate system. Thereafter, the updated aerial imagery 500 may be inspected to determine if features present in the initial aerial imagery 200 have been altered, for example, features 210, 212, and 214. If the features are not present in the updated aerial imagery 500, little to no adjustments may be necessary. However, if at least a portion of the features are readily identifiable, operational adjustments may be made to aid in working over those features in future passes of the agricultural implement 136.

The post-processing may be facilitated by machine learning, feature-based learning, and learning with operator-input. The updates or adjustments may include deviations ⁻from the initial set of operational settings based on the post-processing. The updated settings or adjustments may also include incremental changes to augment the machine learning process.

Additionally, block 612 may further include adjusting the operations-based geographic coordinate map based on third party expertise. For example the third party expertise may include operator input or other input from users, operators, and/or experts with experience in setting adjustments for agricultural implements based on conditions. Additionally, block 612 can further include adjusting the operations-based geographic coordinate map based on a comparison between expected yield and actual yield. For example, an expected yield may be predicted prior to agricultural work. Thereafter, data related to actual yield may be processed. Subsequently, adjustments may be made to geographic coordinate maps based on this prior/actual yield data for similar geographic areas or features.

As described above, a plurality of systems and methods for adjusting operational settings of agricultural implements have been provided. The systems and methods may be facilitated through aerial imagery, one or more processors, and an agricultural implement coupled to a work vehicle. The one or more processors may be implemented as a computer apparatus configured to process imagery to create an operations-based geographic coordinate map including a set of operational settings for the agricultural implement. The computer apparatus may be a general or specialized computer apparatus configured to perform various functions related to image manipulation and processing, including various machine learning algorithms.

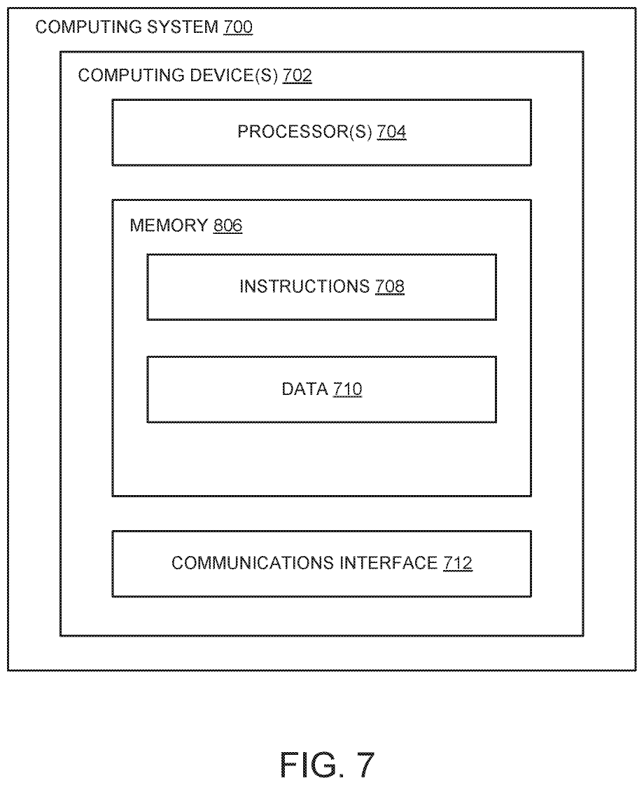

For example, FIG. 7 depicts a block diagram of an example computing system 700 that can be used to implement one or more components of the systems according to example embodiments of the present disclosure. As shown, the computing system 700 can include one or more computing device(s) 702. The one or more computing device(s) 702 can include one or more processor(s) 704 and one or more memory device(s) 706. The one or more processor(s) 704 can include any suitable processing device, such as a microprocessor, microcontroller, integrated circuit, logic device, or other suitable processing device. The one or more memory device(s) 706 can include one or more computer-readable media, including, but not limited to, non-transitory computer-readable media, RAM, ROM, hard drives, flash drives, or other memory devices.

The one or more memory device(s) 706 can store information accessible by the one or more processor(s) 704, including computer-readable instructions 708 that can be executed by the one or more processor(s) 704. The instructions 708 can be any set of instructions that when executed by the one or more processor(s) 704, cause the one or more processor(s) 704 to perform operations. The instructions 708 can be software written in any suitable programming language or can be implemented in hardware. In some embodiments, the instructions 708 can be executed by the one or more processor(s) 704 to cause the One or more processor(s) 704 to perform operations, such as the operations for adjusting* the operational settings of agricultural implements, as described with reference to FIG. 6.

The memory device(s) 706 can further store data 710 that can be accessed by the processors 704. For example, the data 710 can include historical implement adjustment data, current implement adjustment data, incremental adjustment data, machine learning data, aerial image-based machine learning data, and other suitable data, as described herein. The data 710 can include one or more table(s), function(s), algorithm(s), model(s), equation(s), etc. for adjusting operational settings of agricultural implements according to example embodiments of the present disclosure.

The one or more computing device(s) 702 can also include a communication interface 712 used to communicate, for example, with the other components of the system and/or other computing devices, including UAVs, imaging systems, and other devices. The communication interface 712 can include any suitable components for interfacing with one or more network(s), including for example, transmitters, receivers, ports, controllers, antennas, or other suitable components.

It is also to be understood that the steps of the method 600 is performed by the data center 110 or controller 134 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the controller 134 or data center 110 described herein, such as the method 600, is implemented in software code or instructions which are tangibly stored on a tangible computer readable medium. The controller 134 or data center 110 loads the software code or instructions via a direct interface with the computer readable medium or via a wired and/or wireless network. Upon loading and executing such software code or instructions by the controller 134 or data center 110, the controller 134 or data center 110 may perform any of the functionality of the controller 134 or data center 110 described herein, including any steps of the method 600 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

The technology discussed herein makes reference to computer-based systems and actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Although specific features of various embodiments may be shown in some drawings and not in others, this is for convenience only. In accordance with the principles of the present disclosure, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A system for adjusting the operational settings of an agricultural implement, the system comprising:
at least one imaging system configured to generate aerial imagery of a geographic area;
an agricultural implement configured to work the geographic area; and
one or more computing devices in operative communication with the at least one imaging system and the agricultural implement, the one or more computing devices configured to:
process aerial imagery of the geographic area and create an operations-based geographic coordinate map including a set of operational settings for the agricultural implement based at least in part on the initial aerial imagery, the operations-based geographic coordinate map correlating the set of operational settings to the plurality of geographic coordinates; and
process updated aerial imagery of the geographic area and update the operations-based geographic coordinate map based on a comparison between the aerial imagery and the updated aerial imagery.

2. The system of claim 1, wherein the at least one imaging system comprises an unmanned aerial vehicle.

3. The system of claim 1, wherein the agricultural implement includes at least one of a sprayer, fertilizer, tillage implement, planter, or seeder.

4. The system of claim 1, wherein the set of operational settings for the agricultural implement include an initial set of operation settings, the initial set of operational settings being matched to the operations-based geographic coordinate map based on historical data.

5. The system of claim 1, wherein the one or more computing devices are configured to implement a machine learning algorithm or a deep-learning artificial intelligence algorithm to create the operations-based geographic coordinate map.

6. The system of claim 1, wherein the system further comprises a controller associated with the agricultural implement or a work vehicle coupled to the agricultural implement, and wherein the controller is configured to:
receive the generated operations-based geographic coordinate map from the one or more computing devices; and
control an operation of the agricultural implement to work the geographic area based on the operations-based geographic coordinate map.

7. The system of claim 6, wherein the controller is further configured to update the operational settings during operation based on data received from one or more sensors.

8. The system of claim 7, wherein the data received from the one or more sensors includes water content, fertilizer content, soil levels, tillage alignment, crop concentration, or vehicle row alignment.

9. A method for adjusting the operational settings of an agricultural implement coupled to a work vehicle, the method comprising:
receiving, with one or more computing devices, initial aerial imagery associated with a geographic area;
identifying, with the one or more computing devices, a plurality of geographic coordinates within the initial aerial imagery;
generating, with the one or more computing devices, an operations-based geographic coordinate map including a set of operational settings for the agricultural implement based at least in part on the initial aerial imagery, the operations-based geographic coordinate map correlating the set of operational settings to the plurality of geographic coordinates;
receiving, with the one or more computing devices, updated aerial imagery of the geographic area following at least partial completion of an agricultural operation in the geographic area; and
adjusting the operations-based geographic coordinate map based on a comparison between the initial and updated aerial imagery.

10. The method of claim 9, further comprising:
initiating control, with the one or more computing devices, of the agricultural implement so as to perform an agricultural operation within the geographic area based at least in part on the operations-based geographic coordinate map.

11. The method of claim 9, further comprising:
post-processing, with the one or more computing devices, the updated aerial imagery to determine if the set of operational settings associated with the operations-based geographic coordinate map requires adjustments;
wherein the set of operational settings for the agricultural implement includes an initial set of operational settings, the initial set of operational settings being matched to the operations-based geographic coordinate map based on historical data; and,
wherein the adjustments include deviations from the initial set of operational settings based on the post-processing.

12. The method of claim 11, wherein the post-processing comprises post-processing of the initial aerial imagery and the updated aerial imagery in an artificial intelligence post-processor configured to determine the adjustments based on the initial set of operational settings.

13. The method of claim 11, wherein the post-processing comprises post-processing of the initial aerial imagery and the updated aerial imagery with a machine learning post-processor configured to incrementally change the operational settings of the agricultural tool from the initial set of operational settings.

14. The method of claim 1, wherein identifying the geographic coordinates comprises comparing the initial aerial imagery with a set of GPS waypoints within the geographic area.

15. The method of claim 1, wherein generating the operations-based geographic coordinate map comprises processing the initial aerial imagery to determine an initial set of operational settings based on historical data.

16. The method of claim 1, wherein at least one of the initial aerial imagery or the updated aerial imagery is received from one or more unmanned aerial vehicles equipped with an imaging system.

17. The method of claim 1, wherein initiating control of the agricultural implement comprises:
transmitting the generated operations-based geographic coordinate map to a controller associated with the work vehicle or the agricultural implement.

18. The method of claim 17, wherein the controller is configured to update the operational settings during operation based on data received from one or more sensors.

19. The method of claim 18, wherein the data received from the one or more sensors includes water content, fertilizer content, soil levels, tillage alignment, crop concentration, or vehicle row alignment.

20. The method of claim 17, further comprising:
determining, with the one or more computing devices, that the set of operational settings require further adjustment;
generating, with the one or more computing devices, a new set of operational settings based on the determination; and
transmitting the new set of operational settings to the controller.
